(19) United States
(12) Patent Application Publication
(10) Pub. No.: US 2008/0208647 A1
(43) Pub. Date: Aug. 28, 2008

(54) Information Technologies Operations Performance Benchmarking

(76) Inventors: Dale Hawley, Round Rock, TX (US); Michael Boswell, Leander, TX (US); Cary Gumbert, Austin, TX (US); Matthew Hoffman, Austin, TX (US); Stephen Meyer, Austin, TX (US)

Correspondence Address: HAMILTON & TERRILE, LLP, P.O. BOX 203518, AUSTIN, TX, 78720, US

(21) Appl. No.: 11/680,280

(22) Filed: Feb. 28, 2007

(51) Int. Cl. G06F 9/44

(52) U.S. Cl. 705/7

(57) ABSTRACT

A proactive IT infrastructure support system is set forth which provides operations performance benchmarking. The operations performance benchmarking makes use of data that is available from a direct supply model. The operations performance benchmarking collects, analyzes, and formats the data into a single, easy-to-use interface that provides customers an ability quickly evaluate absolute performance of key IT performance metrics and to evaluate relative performance by comparing the results to the customer's choice of a variety of external benchmarks (such as industry peers) and internal benchmarks (site vs. site, and performance to Service Level Agreement).

### BACKGROUND OF THE INVENTION

1. Field of the Invention

The present invention relates to information technologies and more particularly to information technologies operations performance benchmarking.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to characterize a system of many information handing systems as an information technology (IT) infrastructure. It is known to provide enterprise information technology (IT) support services to provide an IT infrastructure that consistently performs according to specifications to assist the success of the business of the customer. The IT infrastructure may be used for an enterprise's communication, database management, inventory tracking, shipment records, website management, business-to-business (B2B) ecommerce, business-to-consumer (B2C) ecommerce, accounting, billing, order tracking, customer support tracking, document management, and a possibly infinite number of other tasks. The IT infrastructure is made up of numerous components (including information handling systems) such as servers, hubs, switches, computers, the links connecting these devices, the software applications running these devices, and so on. Each of these components generally has numerous subcomponents such as a central processing unit (CPU), bus, memory, and similar high-level electrical components. The proper functioning of the IT infrastructure in large part depends on the proper functioning of these components and subcomponents.

There are a number of issues relating to IT infrastructure. For example, with known IT infrastructures, it is difficult to quickly and efficient measure IT performance across an entire enterprise. Also for example, with known IT infrastructures, a standardized methodology for a combination of metrics to measure a volume of IT work and the time required to perform such work is not readily available. Also for example, with known IT infrastructures, a single, standardized measure that provides a single measure of both the volume and time spent addressing IT incidents is not readily available.

Even if such metrics were readily available to provide an absolute measurement, the lack of a standard metric prevents evaluation of relative performance (i.e., benchmarking). Also, Even if such metrics were readily available to provide absolute and relative measurements, the complexity of the metrics and the IT environments they measure would be too complex to provide actionable data that would enable the IT manager to focus resources to identify areas of competency within the environment that could be developed into best practices. Also, even if such metrics were readily available to provide absolute and relative measurements, the complexity of the metrics and the IT environments they measure would be too complex to provide actionable data that would enable the IT manager to focus resources to identify areas of weakness within the environment that benefit from corrective action and optimization.

### SUMMARY OF THE INVENTION

In accordance with the present invention, a proactive IT infrastructure support system is set forth which provides operations performance benchmarking. The operations performance benchmarking makes use of data that is available from a direct supply model. The operations performance benchmarking collects, analyzes, and formats the data into a single, easy-to-use interface that provides customers an ability quickly evaluate absolute performance of key IT performance metrics and to evaluate relative performance by comparing the results to the customer's choice of a variety of external benchmarks (such as industry peers) and internal benchmarks (site vs. site, and performance to Service Level Agreement).

The operations performance benchmarking tool enables a customer to divide an IT environment into sites and view each site's performance relative to the selected benchmark. In certain embodiments, the operations performance benchmarking tool presents a single operations performance benchmarking display which includes historic case activity rate information, case activity rate performance information, time to solution performance information and performance summary information. This single operations performance benchmarking display allows a customer to view performance trends over a multi-year historic period. In certain embodiments, the operations performance benchmarking display will enable a customer to access a wide variety of support and service history from databases of the IT support provider and to manipulate the data to further analyze the IT operations of the customer. Additionally, in certain embodiments, customers may submit internal data for analysis and comparison to data of other similarly situated customers. This capability will enable customers to use a standardized methodology to compare return on investment (ROI), efficiency, and performance across multiple vendor platforms and support structures.

In one embodiment, the invention relates to a method for benchmarking information handling system support which includes accessing support data relating to an information technology (IT) infrastructure, accessing benchmarking data relating to support data of similar IT infrastructures, comparing the support data and the benchmarking data, generating a benchmarking report for the support of the IT infrastructure based upon the comparing, and presenting the benchmarking report to a user to allow the user to quickly evaluate absolute performance of IT support performance and to evaluate relative performance.

In another embodiment, the invention relates to an operations performance benchmarking tool which includes means for accessing support data relating to an information technology (IT) infrastructure, means for accessing benchmarking data relating to support data of similar IT infrastructures, means for comparing the support data and the benchmarking data, means for generating a benchmarking report for the support of the IT infrastructure based upon the comparing, and means for presenting the benchmarking report to a user to allow the user to quickly evaluate absolute performance of IT support performance and to evaluate relative performance.

In another embodiment, the invention relates to an information handling system which includes a processor and memory coupled to the processor. The memory stores an operations performance benchmarking tool which includes instructions for accessing support data relating to an information technology (IT) infrastructure, accessing benchmarking data relating to support data of similar IT infrastructures, comparing the support data and the benchmarking data, generating generate a benchmarking report for the support of the IT infrastructure based upon the comparing, and, presenting the benchmarking report to a user to allow the user to quickly evaluate absolute performance of IT support performance and to evaluate relative performance summary.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an information handling system which includes a proactive IT infrastructure support system having an operations performance benchmarking tool.

FIG. 2 shows a block diagram of a proactive IT infrastructure support system.

FIG. 3 shows a block diagram of the interaction of a number of the tools of the proactive IT infrastructure support system.

FIG. 4 shows a block diagram of the interaction of an operations performance benchmarking tool with a plurality of data sources.

FIG. 5 shows an example display of the operations performance benchmarking tool.

FIG. 6 shows an example display of variability over time presentation of the operating performance benchmarking tool.

FIG. 7 shows an example display of a case activity rate presentation of the operations performance benchmarking tool.

FIG. 8 shows an example display of a time to solution presentation of the operations performance benchmarking tool.

FIG. 9 shows a block diagram of a performance summary presentation of the operations performance benchmarking tool.

### DETAILED DESCRIPTION

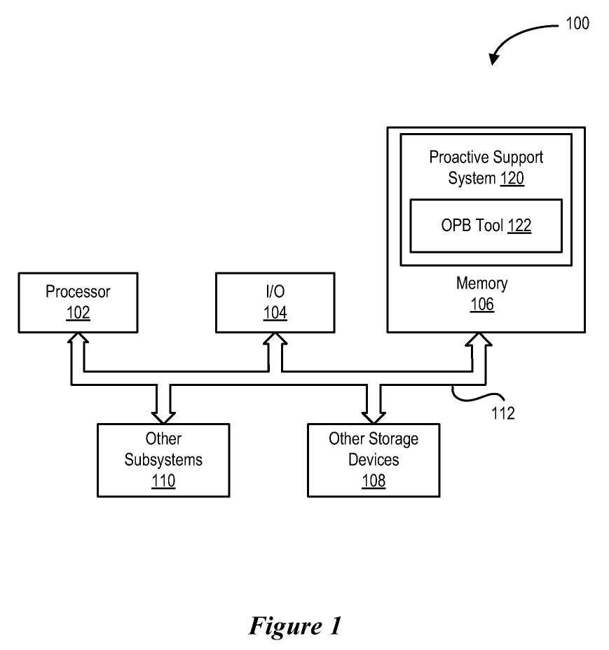

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106 including volatile memory such as Random Access Memory (RAM) and non-volatile memory such as a hard disk and drive, and other storage devices 108, such as an optical disk and drive and other memory devices, and various other subsystems 110, all interconnected via one or more buses 112.

The information handling system 100 includes a proactive IT infrastructure support system 120 having an operations performance benchmarking (OPB) tool 122. The operations performance benchmarking tool 122 makes use of data that is available from a direct supply model. The operations performance benchmarking tool 122 collects, analyzes, and formats the data into a single, easy-to-use interface that provides customers an ability quickly evaluate absolute performance of key IT performance metrics and to evaluate relative performance by comparing the results to the customer's choice of a variety of external benchmarks (such as industry peers) and internal benchmarks (site vs. site, and performance to Service Level Agreement).

The operations performance benchmarking tool 122 enables a customer to divide an IT environment into sites and view each site's performance relative to the selected benchmark. In certain embodiments, the operations performance benchmarking tool presents a single operations performance benchmarking display which includes historic case activity rate information, case activity rate performance information, time to solution performance information and performance summary information. This single operations performance benchmarking display allows a customer to view performance trends over a multi-year historic period.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

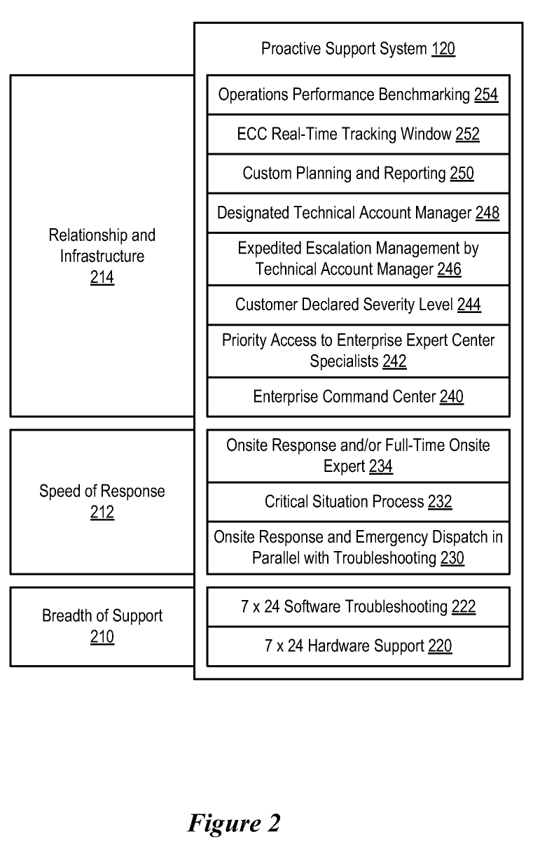

Referring to FIG. 2, a block diagram of a proactive IT infrastructure support system 120 is shown. More specifically, a proactive IT infrastructure support system 120 for a customer includes some or all of a plurality of key features such as breadth of support features 210, speed of response features 212 and relationship and infrastructure features 214.

The breadth of support features 210 can include a hardware support feature 220 as well as a software trouble shooting feature 222. The speed of response features 212 can include an onsite response with emergency dispatch in parallel with troubleshooting feature 230, a critical situation processes feature 232 and an onsite response as well as a full time onsite expert feature 234. The relationship and infrastructure features 214 can include an enterprise command center 240, a priority access to enterprise expert center specialists feature 242, a customer declared security level feature 244, an expedited escalation management by technical account manager feature 246, a designated technical account manager feature 248, a custom planning and reporting feature 250, enterprise command center (ECC) real time tracking window feature 252 and an operations performance benchmarking feature 254.

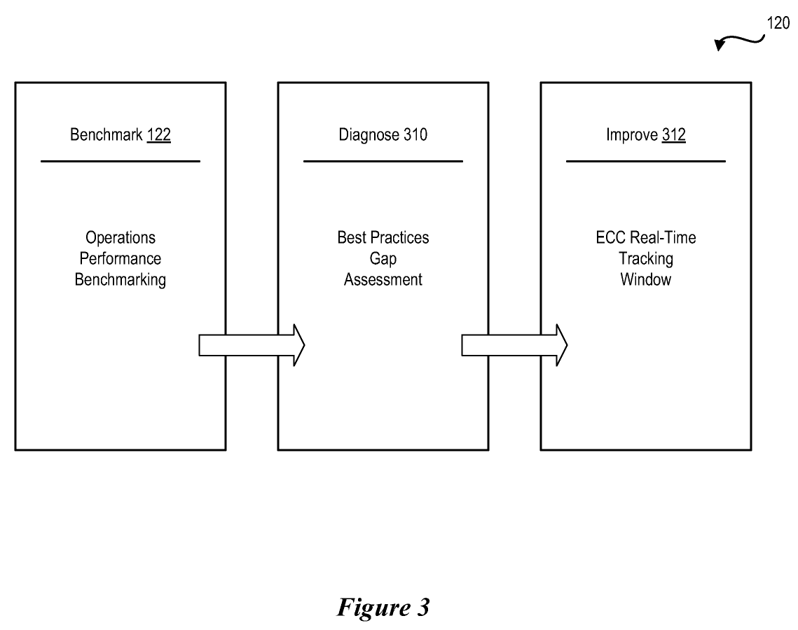

Referring to FIG. 3, a block diagram of the interaction of a number of the tools of the proactive IT infrastructure support system is shown. More specifically, the proactive IT infrastructure support system can include the operations performance benchmarking tool 122 as well as a diagnostic tool 310 and an improvement tool 312. The operations performance benchmarking tool provides a reporting capability with historic trending of case activity rate, comparisons to industry benchmarks and the ability to compare case activity rate and time to solution performance at an individual site level.

The information generated by and derived from the operations benchmarking tool 122 is provided to the diagnostic tool 310. The diagnostic tool 310 provides a customer with an online capability to access methodologies such as an IT infrastructure library (ITIL), to enable the customer to asses their organizations maturity in a variety of IT capabilities and to determine whether opportunities for IT improvement exist. The improvement tool 312 enables support customers to view open dispatches using real time satellite imagery as well as a variety of other support type tracking information.

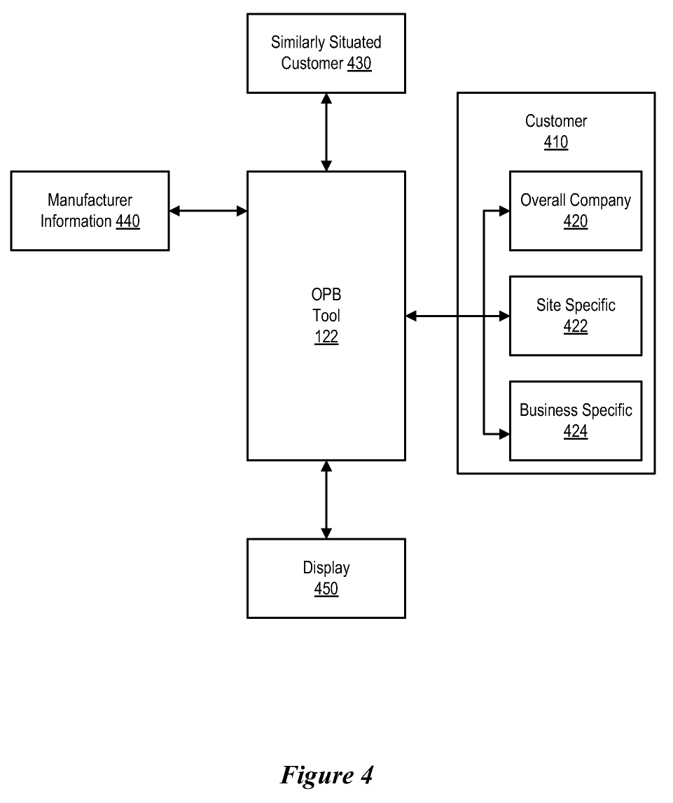

Referring to FIG. 4, a block diagram of the interaction of an operations performance benchmarking tool 122 with a plurality of data sources is shown. More specifically, the operations performance benchmarking tool 122 receives support data from a customer 410. The support data from the customer can include overall company support data 420 as well as site specific support data 422 or business specific data 424. The operations performance benchmarking tool 122 also receives data representing IT performance data 430 for similarly situated businesses. This data or some portion of this data provides benchmark data.

The operations performance benchmarking tool also receives customer specific manufacturer information 440. The customer specific manufacturer information 440 can be derived from manufacturing data based upon information handling systems or information handling system components that are directly supplied to the customer by an information handling system manufacturer. The customer specific manufacturer information can include data that is specific to each supplied information handling system such as the type of system, the components installed on the system etc. The customer specific manufacturer information can also include unique identifiers, such as service tags, that are associated with each supplied information handling system. The operations performance benchmarking tool 122 generates reports based upon the various data that may be presented to the customer via a display 450.

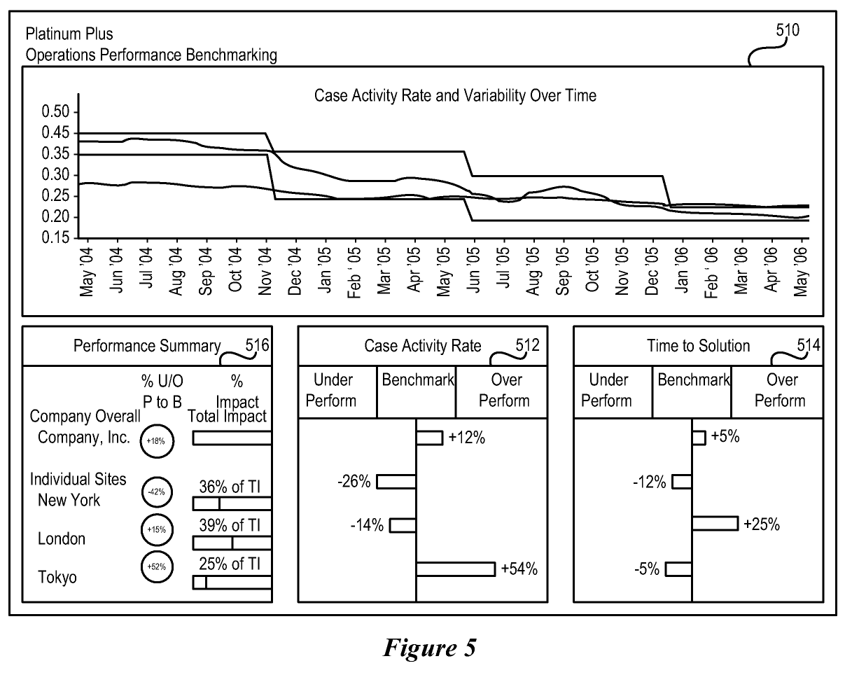

FIG. 5 shows an example benchmarking report screen presentation 500 of the operations performance benchmarking tool 122. More specifically, the benchmarking report screen presentation 500 includes a case activity rate over time portion 51 0, a case activity rate portion 512, a time to solution portion 514 and a performance summary portion 516. The operations performance benchmarking tool 122 can generate for example, a monthly report that compares a support customer environment with a benchmark of the customer's choice. The report tracks case activity rate and time to solution for each site with a customer environment enabling a comparative analysis to a selected benchmark and across sites. Providing this information enables a customer and their technical account manager (TAM) to identify sites that may provide best practices and to leverage the finings to improve lagging sites.

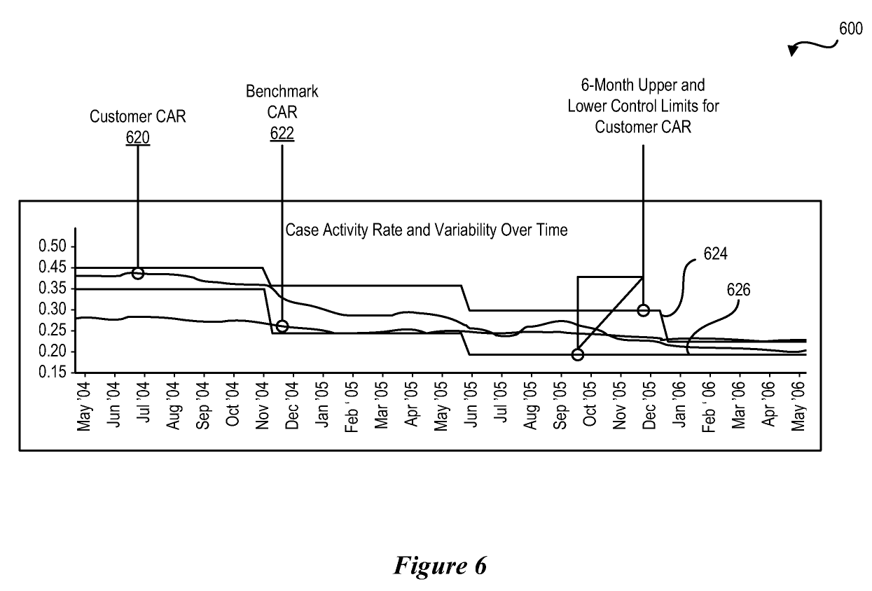

FIG. 6 shows an example display of a variability over time presentation 610 of the operations performance benchmarking tool 122. More specifically, the variability over time presentation 610 includes a customer case activity report indication 620, a benchmark case activity report indication 622, as well as upper and lower control limits for the customer case activity 630, 632, respectively. The customer case activity report indication 620 and the benchmark cases activity report indication 622 are presented as different colors (e.g., yellow and blue, respectively). Additionally, the upper and lower control limits for the customer case activity 630, 632 are also presented in a color different from that of the customer case activity report indication 620 and the benchmark cases activity report indication 622 (e.g., red).

The customer case activity report indication 620 presents a moving average of a customer's case activity rate over a historic period. For example, in one embodiment, the customer case activity report indication presents a 26-week moving average over a two year historic period. The benchmark case activity report indication 622 presents a moving average of a benchmark case activity rate over a historic period. For example, in one embodiment, the benchmark case activity report indication presents a 26-week moving average over a two year historic period. The benchmark case activity rate may be from a peer or from data derived from a plurality of peers.

The upper and lower control limits for the customer case activity 630, 632 present upper and lower control limits between which most of the data for a customer case activity rate should plot. The upper and lower control limits are regularly calculated to track trends shifts. The wider the limits, the more variable, and therefore less stable, the environment. For example, in one embodiment, the upper and lower control limits represent six-sigma limits (with ±3 standard deviation above and below the 26-week moving average) between which 99.7% of the data should plot. The control limits illustrate variability in the environment as well as trend shifts quarter to quarter. Unlike real-time manufacturing controls, this data has been smoothed over a predetermined amount of time (e.g., 26-weeks). Thus this control limit data can be used to identify weekly trends rather than hourly spikes.

The cases activity rate is a weekly quotient in which the numerator is the number of cases opened and the denominator is the number of covered systems in the environment (i.e., the number of systems which are supported). The quotient is then annualized to provide the case activity rate. Thus the case activity rate represents a number of cases per system per year that a customer would expect to see in their environment.

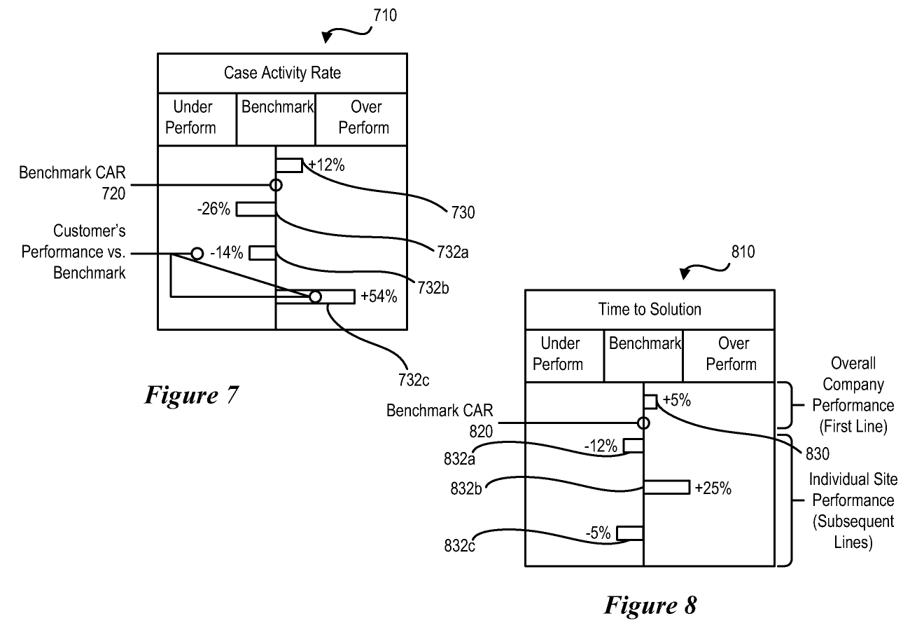

FIG. 7 shows an example display of a case activity rate presentation 710 of the operations performance benchmarking tool. More specifically, the case activity rate presentation 710 provides a summary of case activity report values in a performance window that corresponds to the last weekly data points in the historic case activity report 610. The case activity rate presentation 710 presents a benchmark case activity rate 720. The case activity rate presentation 710 also presents an overall company performance indication 730 as well as more particular company performance indications 732a, 732b, 732c. In one embodiment, the more particular company performance indications 732a, 732b, 732c correspond to individual site performance.

The overall company performance indication 730 and the more particular company performance indications 732 are presented in different colors depending on whether the performance is better or worse than the benchmark performance (e.g., green and red, respectively). The benchmark performance indication 720 may also be presented in a color (e.g., blue) different from the customer performance indications. Customers with a case activity rate less than the benchmark have a better then benchmark performance and customers with a case activity rate more than the benchmark have a case activity rate worse than the benchmark performance. The values used for the comparison of case activity rate are based on a moving average as of a last reported time selection. In one embodiment, the values used for the comparison are based on a 26-week moving average as of the last week reported.

FIG. 8 shows an example display of a time to solution presentation 810 of the operations performance benchmarking tool. More specifically, the time to solution presentation 810 provides a summary of time to solution values in a performance window that corresponds to the last weekly data points in the historic case activity report 610. The time to solution presentation 710 presents a benchmark time to solution rate 820. The time to solution presentation 810 also presents an overall company performance indication 830 as well as more particular company performance indications 832a, 832b, 832c. In one embodiment, the more particular company performance indications 832a, 832b, 832c correspond to individual site performance.

The overall company performance indication 830 and the more particular company performance indications 832 are presented in different colors depending on whether the performance is better or worse than the benchmark performance (e.g., green and red, respectively). The benchmark performance indication 820 may also be presented in a color (e.g., blue) different from the customer performance indications. Customers with a time to solution rate less than the benchmark have a better then benchmark performance and customers with a time to solution rate more than the benchmark have a time to solution rate worse than the benchmark performance. The values used for the comparison of time to solution rate are based on a moving average as of a last reported time selection. In one embodiment, the values used for the comparison are based on a 26-week moving average as of the last week reported.

The time to solution represents a total time from which a support request is initiated (i.e., opened) to the time that the customer agrees that the support request is resolved.

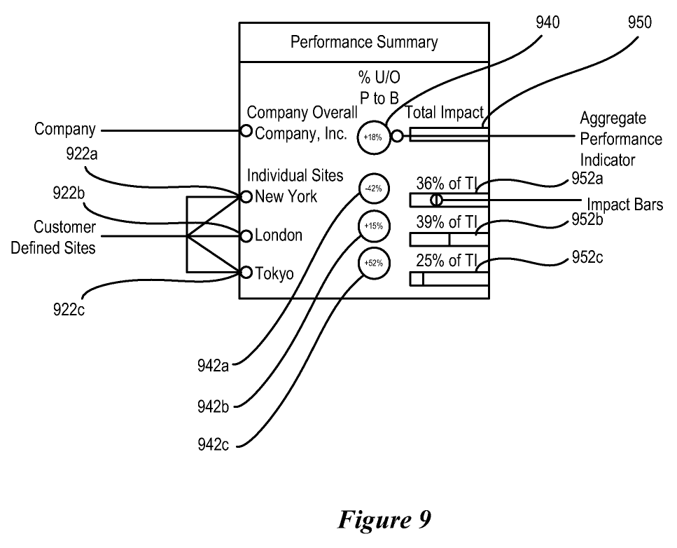

FIG. 9 shows a block diagram of a performance summary presentation 910 of the operations performance benchmarking tool. The performance summary presentation 910 includes a company indication 920 as well as company defined indications 922a, 922b, 922c. The performance summary indication 910 also includes an aggregate performance indication portion 930 and an impact indication portion 932.

The aggregate performance indication portion 930 includes aggregate performance indicator 940 that corresponds to the company indication as well as a plurality of aggregate performance indicators 942a, 942b, 942c, that correspond to each of the company defined indications 922a, 922b, 922c, respectively. The aggregate performance indicators 942 compare a customer's estimated hours spent addressing cases within the customer environment to a benchmark number of hours for an environment having a substantially equal number of systems.

The impact indication portion 930 includes an impact performance indicator 950 that corresponds to the company indication as well as a plurality of impact performance indicators 952a, 952b, 952c, that correspond to each of the company defined indications 922a, 922b, 922c, respectively. The impact performance indicator 952 indicates as a percentage each site's contribution to the total number of hours spent working on case. The company overall impact performance indicator 950 will always indicate a value of 100%.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for benchmarking information handling system support comprising:
accessing support data relating to an information technology (IT) infrastructure;
accessing benchmarking data relating to support data of similar IT infrastructures;
comparing the support data and the benchmarking data;
generating generate a benchmarking report for the support of the IT infrastructure based upon the comparing; and,
presenting the benchmarking report to a user to allow the user to quickly evaluate absolute performance of IT support performance and to evaluate relative performance.

2. The method of claim 1, further comprising:
accessing customer specific manufacturer information; and,
using the customer specific manufacturer information when generating the benchmarking report

3. The method of claim 1, wherein:
the benchmarking report includes at least one of a case activity rate over time portion, a case activity rate portion, a time to solution portion and a performance summary portion.

4. The method of claim 3, wherein:
the case activity rate over time portion includes a customer case activity report indication, a benchmark case activity report indication, and upper and lower control limits for the customer case activity.

5. The method of claim 3, wherein:
the case activity rate portion includes a benchmark case activity rate, an overall company performance indication, and at least one particular company performance indication.

6. The method of claim 3, wherein
the time to solution portion includes a benchmark time to solution rate, an overall company performance indication, and at least one more particular company performance indication.

7. The method of claim 3, wherein
the performance summary portion includes a company indication, at least one company defined indication, an aggregate performance indication portion and an impact indication portion.

8. An operations performance benchmarking tool comprising:
means for accessing support data relating to an information technology (IT) infrastructure;
means for accessing benchmarking data relating to support data of similar IT infrastructures;
means for comparing the support data and the benchmarking data;
means for generating generate a benchmarking report for the support of the IT infrastructure based upon the comparing; and,
means for presenting the benchmarking report to a user to allow the user to quickly evaluate absolute performance of IT support performance and to evaluate relative performance.

9. The operations performance benchmarking tool of claim 8, further comprising:
means for accessing customer specific manufacturer information; and,
means for using the customer specific manufacturer information when generating the benchmarking report

10. The operations performance benchmarking tool of claim 8, wherein:
the benchmarking report includes at least one of a case activity rate over time portion, a case activity rate portion, a time to solution portion and a performance summary portion.

11. The operations performance benchmarking tool claim 10, wherein:
the case activity rate over time portion includes a customer case activity report indication, a benchmark case activity report indication, and upper and lower control limits for the customer case activity.

12. The operations performance benchmarking tool of claim 10, wherein
the case activity rate portion includes a benchmark case activity rate, an overall company performance indication, and at least one particular company performance indication.

13. The operations performance benchmarking tool of claim 10, wherein
the time to solution portion includes a benchmark time to solution rate, an overall company performance indication, and at least one more particular company performance indication.

14. The operations performance benchmarking tool of claim 10, wherein
the performance summary portion includes a company indication, at least one company defined indication, an aggregate performance indication portion and an impact indication portion.

15. An information handling system comprising
a processor;
memory coupled to the processor, the memory storing an operations performance benchmarking tool, the operations performance benchmarking tool including instructions for
accessing support data relating to an information technology (IT) infrastructure;
accessing benchmarking data relating to support data of similar IT infrastructures;
comparing the support data and the benchmarking data;
generating generate a benchmarking report for the support of the IT infrastructure based upon the comparing; and,
presenting the benchmarking report to a user to allow the user to quickly evaluate absolute performance of IT support performance and to evaluate relative performance.

16. The information handling system of claim 15, wherein the operations performance benchmarking tool further comprises instructions for:
accessing customer specific manufacturer information; and,
using the customer specific manufacturer information when generating the benchmarking report

17. The information handling system of claim 15, wherein:
the benchmarking report includes at least one of a case activity rate over time portion, a case activity rate portion, a time to solution portion and a performance summary portion.

18. The information handling system of claim 18, wherein:
the case activity rate over time portion includes a customer case activity report indication, a benchmark case activity report indication, and upper and lower control limits for the customer case activity.

19. The information handling system of claim 18, wherein:
the case activity rate portion includes a benchmark case activity rate, an overall company performance indication, and at least one particular company performance indication.

20. The information handling system of claim 18, wherein
the time to solution portion includes a benchmark time to solution rate, an overall company performance indication, and at least one more particular company performance indication.

21. The information handling system of claim 18, wherein
the performance summary portion includes a company indication, at least one company defined indication, an aggregate performance indication portion and an impact indication portion.
